(19) United States
(12) Patent Application Publication
(10) Pub. No.: US 2025/0105693 A1
(43) Pub. Date: Mar. 27, 2025

(54) COMPONENT USED AS AN ELECTRICAL INSULATION BARRIER BASED ON A POLYARYLETHERKETONE (PAEK) AND A POLYPHENYLSULFONE (PPSU)

(71) Applicant: Solvay Specialty Polymers USA, LLC, Alpharetta, GA (US)

(72) Inventors: Victoria LEE, Brookhaven, GA (US); Mohammad Jamal EL-HIBRI, Atlanta, GA (US); Jason RICH, SUWANEE, GA (US)

(21) Appl. No.: 18/730,974

(22) PCT Filed: Feb. 9, 2023
(86) PCT No.: PCT/EP2023/053221

§ 371 Date: Jul. 22, 2024

Related U.S. Application Data
(60) Provisional application No. 63/308,525, filed on Feb. 10, 2022.

(30) Foreign Application Priority Data
Jul. 20, 2022 (EP) 22186074.5

(51) Int. Cl. H02K 3/34; C08K 3/34; C08K 3/38; C08L 71/00; H02K 1/16; H02K 3/30

(52) U.S. Cl. CPC H02K 3/345; C08K 3/34; C08K 3/38; C08L 71/00; H02K 1/16; H02K 3/30; C08K 2003/343; C08K 2003/385; C08K 2201/005; C08K 2201/014; C08K 2201/016; C08L 2203/16; C08L 2203/20; C08L 2203/30; C08L 2205/24

(57) ABSTRACT

This present invention pertains to the art of electric motors or generators and relates to a component, such as a slot liner or a slot wedge, that is used as an electrical insulation barrier in the slots of a stator that are each configured to receive electrical windings. The component is made from a composition based on polyaryletherketone (PAEK) and a polyphenylsulfone (PPSU) which exhibits a combination of chemical and mechanical properties.

The present application claims the priority of U.S. provisional application 63/308,525 filed on 10Feb. 2022 and European patent application 22186074.5 filed on 20 Jul. 2022, the content of which being entirely incorporated herein by reference for all purposes. In case of any incoherency between the present application and the PCT application that would affect the clarity of a term or expression, it should be made reference to the present application only.

### TECHNICAL FIELD

This present invention pertains to the art of electric motors or generators. More specifically, it relates to a component, such as a slot liner or a slot wedge, that is used as an electrical insulation barrier in the slots of a stator that are each configured to receive electrical windings. The component is made from a composition based on polyaryletherketone (PAEK) and a polyphenylsulfone (PPSU) which exhibits a combination of chemical and mechanical properties.

### BACKGROUND ART

Electric motors and generators are used in a wide range of applications. Electric motors convert electrical energy into mechanical energy in the form of motion. Electric generators convert mechanical energy into electrical energy. Although the two machines have different functions, they both comprise a stator which is the stationary part of the machine and which comprises conductors, usually in the form of copper wire coils, inserted in slots.

In the case of a motor, the stator produces a magnetic field to interact magnetically with a rotor or other moving element. Although the stator in an electric motor is stationary, it provides the driving forces that rotate the rotor. Stator configurations may vary for different motor applications and generally have a “core” formed from laminations of steel or other magnetic material. This core provides the path for magnetic flux threading through the stator. The slots are formed in this core to provide locations for coils of electrical conductors. Current passing through the conductive coils creates the magnetic field used for the operation of the motor.

To avoid damages and to improve the performance of the electric machine, an electrical insulation barrier between the windings and the stator needs to be present in the slots of the stator. Two components are generally inserted into the slots for this: a slot liner and a slot wedge.

A slot liner is a component in an electrical machine such as a motor or generator which provides an electrical insulation barrier between the windings and the stator. The component is cut and shaped from a film to fit within the slots of the motor or generator.

A slot wedge is a slot closure to hold the stator windings in the slots.

EP 2738219 (D1) discloses ternary compositions comprising at least one poly (aryletherketone) (PAEK), at least one polyphenylsulfone (PPSU), at least one other poly (arylethersulfone) polymer and optionally certain reinforcing fillers. D1 also discloses the use of these compositions as electric and electromagnetic wire insulation coatings (§ [0151]). WO 2020/011814 (D2) relates to an article comprising a polymeric component and a metallic coating. US 2020/009785 (D3) relates to a method for manufacturing three-dimensional (3D) objects using an additive manufacturing system. WO 2016/034624 (D4) relates to a sulfone polymer composition. Examples CE-12, CE-13 and CE-14 disclose a polymer composition with a proportion of PAEK (PEEK) lower than in claim 1. WO 2007/107519 (D5) relates to reinforced polyaryletherketone compositions with a proportion of PAEK (PEEK) lower than in claim 1. None of these documents discloses the subject-matter of claim 1.

US 2011/0095641 (D6) discloses slot liners. There is no disclosure of the polymeric composition as claimed.

### TECHNICAL PROBLEM TO BE SOLVED

The slot liners and slot wedges are generally made of a polymeric material since this type of material can be shaped easily and at a low cost. Yet, currently used polymeric materials are either very expensive Aramid (aka Nomex®) or are lower performing polymers that have to be used with a high thickness to achieve a sufficient electrical insulation or the required mechanical integrity. DK7-0953M commercialized by SolEpoxy is an epoxy-based thermoset coating powder used in the field as an insulation material, but it is known that epoxy-based thermosets are hard to recycle.

Moreover, in the case of a slot liner or a slot wedge, higher thicknesses usually result in a film with a lower flexibility.

The polymeric material used for the electrical insulation should exhibit a good combination of chemical resistance (notably in the environment of a motor, the component should exhibit an excellent resistance to crease) and mechanical properties (high stiffness with mechanical ductility, high temperature resistance). As the electric vehicle industry is expected to shift from 400 Volt systems to 800 Volt or higher, improved components are expected to be demanded.

Moreover, the polymeric material used for the insulation should be easily transformed into the component of the invention. For instance, the polymeric material should be easily transformed into a film notably with a low thickness (e.g. between 2 and 5 mils). In this regard, a slot liner with a low thickness makes it possible to increase the density of conductors in the cavities which helps increase the power of the motor. Alternatively under a different perspective, a higher density makes it possible to reduce the size of the motor without affecting the power.

There is therefore a need for a recyclable component for use as an efficient electrical insulation barrier in the slots of a stator combining a low thickness and a good combination of chemical and mechanical properties. In particular, the component should exhibit a high tensile elongation at break while maintaining thermal (heat deflection temperature) and electrical insulation properties.

### BRIEF DISCLOSURE OF THE INVENTION

The invention is set out in the appended set of claims.

Thus, the invention relates to a component as defined in claims 1-41. It relates to a component, notably a slot liner or a slot wedge, for use as an electrical insulation barrier in the slots of a stator, comprising or being made of a composition (C). This component is designed to be inserted into a slot of a stator.

The invention also relates to the use of a composition (C) for the preparation of a slot liner or a slot wedge as defined in claim 42.

It also relates to an electric motor as defined in claims 43-44.

It also relates to an electric generator as defined in claims 45-46.

The invention also relates to the compositions (C) and (C*) as defined below and in claim 47, notably exhibiting the physico-chemical properties and/or the insulation properties as defined below. These subject-matters are now defined in more detail below.

### FIGURES

FIG. 1 represents a stator (1) comprising slots (2), each slot comprising a slot liner (3).

FIG. 2 represents a stator (1) comprising slots (2), each slot being closed by a slot wedge (4).

As is visible, both components-represented in darker color-are disposed in different places of the slots of the stator.

### GENERAL DEFINITIONS

For the sake of clarity, throughout the present application, the following definitions and precisions are used.

Unless otherwise indicated, the percentages are given by weight (wt %). Moreover, the proportions of the ingredients of the compositions are given by wt % relative to the total weight of the composition.

Unless otherwise indicated, the proportions of the recurring units in the polymers disclosed herein are given in mol %, relative to the total amount of recurring units.

The melting temperature Tₘ of PAEK is the temperature determined as the peak temperature of the melting endotherm on the 2^{nd} heat scan in differential scanning calorimeter (DSC) according to ASTM D3418-03, E1356-03, E793-06, E794-06 and using heating and cooling rates of 20° C./min. For the purpose of the present description, a polymer is crystalline if a melting endotherm is detected in the second heat scan.

The heat of fusion means the heat of fusion as measured by DSC according to ASTM D3418-03 using the second heat scan. The area is taken between the melting endotherm and the baseline where the baseline is drawn from the point at T=Tg+50° C. until the end of the melting peak defined where the peak returns to a baseline. Tg represents the glass transition and is determined according to ASTM D3418.

When numerical ranges are indicated, range ends are included.

The term “halogen” includes fluorine, chlorine, bromine and iodine, unless indicated otherwise.

The term “aromatic” denotes any mono-or polynuclear cyclic group (or moiety) having a number of π electrons equal to 4n+2, wherein n is 0 or any positive integer; an aromatic group (or moiety) can be an aryl or an arylene group (or moiety).

An “aryl group” is a hydrocarbon monovalent group consisting of one core composed of one benzenic ring or of a plurality of benzenic rings fused together by sharing two or more neighboring ring carbon atoms, and of one end. Non-limitative examples of aryl groups are phenyl, naphthyl, anthryl, phenanthryl, tetracenyl, triphenylyl, pyrenyl, and perylenyl groups. The end of an aryl group is a free electron of a carbon atom contained in a (or the) benzenic ring of the aryl group, wherein an hydrogen atom linked to said carbon atom has been removed. The end of an aryl group is capable of forming a linkage with another chemical group.

An “arylene group” is a hydrocarbon divalent group consisting of one core composed of one benzenic ring or of a plurality of benzenic rings fused together by sharing two or more neighboring ring carbon atoms, and of two ends. Non-limitative examples of arylene groups are phenylenes, naphthylenes, anthrylenes, phenanthrylenes, tetracenylenes, triphenylylenes, pyrenylenes, and perylenylenes. An end of an arylene group is a free electron of a carbon atom contained in a (or the) benzenic ring of the arylene group, wherein an hydrogen atom linked to said carbon atom has been removed. Each end of an arylene group is capable of forming a linkage with another chemical group.

### DISCLOSURE OF THE INVENTION

The invention relates to a component, such as a slot liner or a slot wedge that is used as an electrical insulation barrier in the slots of a stator of an electric motor or generator. The slots are configured to receive electrical windings. This component comprises or is made of a polymer composition (C) which is defined in more details below.

### SLOT LINER

The component of the invention may be a slot liner. As the slot liner needs to be cut and shaped to fit within the slots of the stator, it is generally in the form of a film with a thickness lower than 1.0 mm, preferably lower than 0.50 mm, even more preferably lower than 0.20 mm. The thickness of the slot liner is usually at least 0.02 mm.

The thickness of the slot liner may be between 0.02 and 0.18 mm, more particularly between 0.05 and 0.15 mm. The composition of the invention makes it possible to reduce the thickness of a slot liner to gain space in the slot while maintaining a good combination of properties.

According to an embodiment, the slot liner is made of the composition (C).

According to another embodiment, the slot liner comprises the composition (C). For instance, the slot liner may be multilayer. It may comprise two layers (L₁) and (L₁*) made of or comprising a composition (C) and one other layer (L₂) between layers (L₁) and (L₁*) made of a polymer composition different from composition (C) or (C*).

The invention also relates to a stator assembly used in an electrical machine comprising a stator core having a plurality of slots that are each configured to receive electrical windings and at least one slot liner of the invention.

The invention also relates to an electrical machine such as a motor or generator comprising at least one slot liner of the invention.

The electrical machine generally comprises: a stator and a rotor, the stator comprising several slots in which windings are placed wherein at least one slot liner as defined herein is disposed in one slot between the stator core and the windings for insulating the stator core from the windings.

The slot liner may be prepared with the conventional techniques of transformation of the polymeric materials such as (co)extrusion.

For instance, a convenient method of preparation of a slot liner consists in extruding the polymer composition (C) into a film, generally at the desired thickness of the slot liner. Then the slot liner is formed from a section that is cut from the film and contoured so as to fit into the space within the slot. In the case of a multilayer slot liner, a coextrusion process is used in a similar manner.

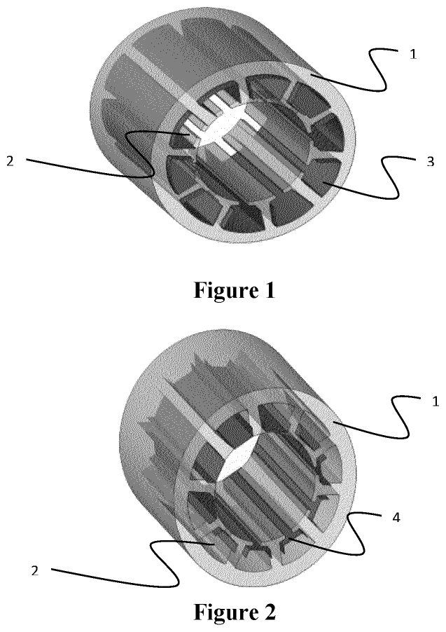

The slot liner may be shaped into different configurations and sizes For instance, the slot liner may be as depicted on FIG. 7 of U.S. Pat. No. 4,151,436, FIG. 7 of U.S. Pat. No. 4,247,978, FIG. 1 of U.S. Pat. No. 3,943,392, FIG. 3 of U.S. Pat. No. 5,306,976, FIG. 3 of U.S. Pat. No. 1,058,975,172, FIG. 6 of US 2010/0141079 A1 or FIG. 2 of US 2011/0095641 A1 or FIG. 1 of US 2016/0065025.

Typically, the slot liner is substantially U-shaped.

Typically, the slot liner is designed, e.g. to be folded on itself, to facilitate the axial insertion in or along the slot.

### Slot Wedge

The component of the invention may also be a slot wedge. According to an embodiment, the slot wedge is made of the composition (C).

According to another embodiment, the slot wedge comprises the composition (C).

The slot wedge may be in the form of a film with a thickness lower than 1.0 mm, preferably lower than 0.50 mm, even more preferably lower than 0.20 mm. The thickness of the slot wedge is usually at least 0.02 mm.

The thickness of the slot wedge may be between 0.02 and 0.18 mm, more particularly between 0.05 and 0.15 mm. The composition of the invention makes it possible to reduce the thickness of a slot wedge to gain space in the slot while maintaining a good combination of properties.

The slot wedge may be prepared with the conventional techniques of transformation of the polymeric materials such as extrusion or injection moulding.

For instance, a convenient method of preparation of a slot wedge consists in injection moulding the slot wedge.

### Composition (C)

The composition (C) comprises or consists essentially or consists of:
at least 50.0 wt % of at least one polyaryletherketone (PAEK);
between 15.0 and 42.0 wt % of at least one polyphenylsulfone (PPSU);
between 8.0 and 25.0 wt % of at least one inorganic filler;
optionally at most 3.0 wt % of at least one nucleating agent other than the inorganic filler;
optionally, at least one plastic additive.

### PAEK

Composition (C) comprises at least 50.0 wt % of at least one polyaryletherketone (PAEK). The proportion of PAEK(s) may more particularly be between 50.0 and 65.0wt %, more particularly between 50.0 and 60.0 wt %. This proportion is preferably between 53.0 and 60.0 wt % or even between 55.0 and 60.0 wt %.

Composition (C) may comprise only one PAEK.

Composition (C) may also comprise more than one PAEK. In that case, each PAEK may be characterized by distinct recurring units and/or distinct weight average molecular weights (M_{w}). For the avoidance of doubt, it is highlighted that in that case, the proportions given above correspond to the total proportion of PAEKs.

At least one PAEK preferably exhibits a heat of fusion as measured from the second heat of differential scanning calorimetry test according to ASTM D3418-03 of at least 35.0 J/g, preferably at least 40.0 J/g, and more preferably at least 45.0 J/g.

The PAEK preferably exhibits a melt viscosity of at least 200 Pa s measured according to ASTM D3835 at 400° C. and a 1000 1/s shear rate. This melt viscosity is usually at most 600 Pa s. The melt viscosity of the PAEK is between 200 and 600 Pa s, preferably between 250 and 600 Pa s measured according to ASTM D3835 at 400° C. and a 1000 1/s shear rate.

The PAEK preferably exhibits a melting temperature of at least 300° C., preferably at least 320° C.

A “poly (aryl ether ketone) (PAEK)” denotes a polymer comprising arylene groups linked by oxygen atoms and/or carbonyl groups and wherein the polymer comprises more than 50.0 mol % of recurring units (RPAEK) including the unit of formula (I):

—Ar′—C(═O)—Ar″—(I)

where Ar′ and Ar″, equal to or different from each other, are optionally substituted arylene groups. Each substituent that may be present on each aromatic group is selected in the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium. The number of substituent(s) that may be present on each aromatic group is j′ which can be zero or an integer ranging from 1 to 4. j′ is preferably 0. Ar′ and Ar″ are more particularly selected, independently from one another, in the group consisting of phenylene and biphenylene.

The recurring units (RPAEK) is selected in the group consisting of units of formulae (J-A) to (J-Q) below:

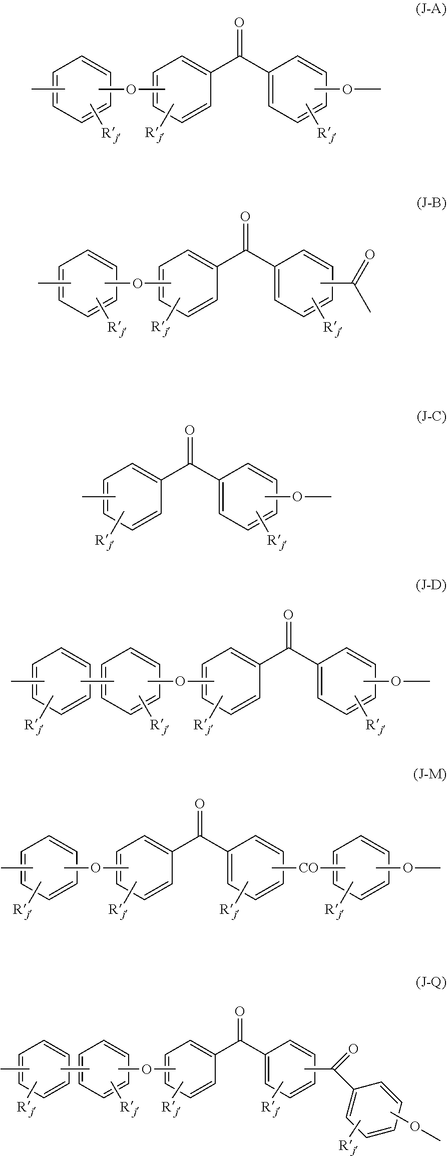

where each R′ of R′_{j′}, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and j′ is zero or an integer ranging from 1 to 4. Preferably, j′ is zero.

More particularly, the PAEK is selected from the group consisting of PEEK, PEKK, PEK, PEEKK, PEKEKK and combinations thereof. According to a preferred embodiment, the PAEK is selected from the group of PEEK, PEKK and combinations thereof. According to another preferred embodiment, the PAEK is PEEK.

### PEEK

More particularly, the PAEK is a poly (ether ether ketone) (PEEK). As used herein, a “poly (ether ether ketone) (PEEK)” denotes a polymer of which more than 50.0 mol % of the recurring units are recurring units of formula (J′-A):

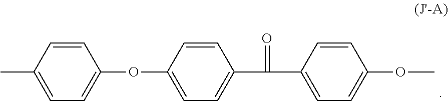

Preferably at least 60.0 mol %, preferably at least 70.0 mol %, preferably 80.0 mol %, preferably at least 90.0 mol %, preferably at least 95.0 mol %, preferably at least 99.0 mol %, and most preferably all of recurring units of the PEEK are recurring units (J′-A).

### PEKK

More particularly, the PAEK is a poly (ether ketone ketone) (PEKK). As used herein, a “poly (ether ketone ketone) (PEKK)” denotes a polymer of which more than 50.0 mol % of the recurring units are a combination of recurring units of formula (J′-B) and formula (J″-B):

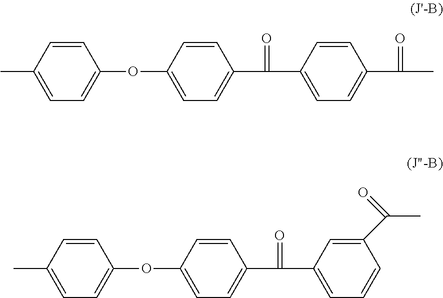

Preferably at least 60.0 mol %, preferably at least 70.0 mol %, preferably at least 80.0 mol %, preferably at least 90.0 mol %, preferably at least 95.0 mol %, preferably at least 99.0 mol % and most preferably all of recurring units of the PEKK are a combination of recurring units (J′-B) and (J″-B).

### PEK

More particularly, the PAEK may be a poly (ether ketone) (PEK). As used herein, a “poly (ether ketone) (PEK)” denotes a polymer of which more than 50.0 mol % of the recurring units are recurring units of formula (J′-C):

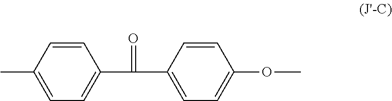

Preferably at least 60.0 mol %, preferably at least 70.0 mol %, preferably at least 80.0mol %, preferably at least 90.0 mol %, preferably at least 95.0 mol %, preferably at least 99.0 mol %, and most preferably all of recurring units of the PEK are recurring units (J′-C).

### PEEKK

More particularly, the PAEK is a poly (ether ether ketone ketone) (PEEKK). As used herein, a “poly (ether ether ketone ketone) (PEEKK)” denotes a polymer of which more than 50.0 mol % of the recurring units are recurring units of formula (J′-M):

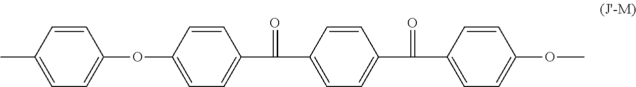

Preferably at least 60.0 mol %, preferably at least 70.0 mol %, preferably at least 80.0mol %, preferably at least 90.0 mol %, preferably at least 95.0 mol %, preferably at least 99.0 mol %, and most preferably all of recurring units of the PEEKK are recurring units (J′-M).

### PEKEKK

More particularly, the PAEK is a PEKEKK polymer. As used herein, a “PEKEKK” denotes a polymer of which more than 50.0 mol % of the recurring units are recurring units of formula (J′-Q):

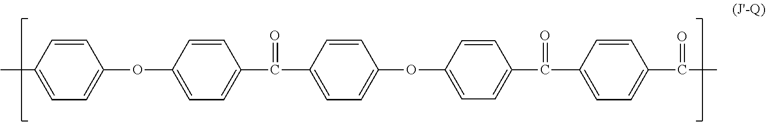

Preferably at least 60.0 mol %, preferably at least 70.0 mol %, preferably at least 80.0mol %, preferably at least 90.0 mol %, preferably at least 95.0 mol %, preferably at least 99.0 mol %, and most preferably all of recurring units are recurring units (J′-Q).

### Preparation of the PAEKs

The PAEKs are prepared by polycondensation techniques well known in the art, notably a nucleophilic route or an electrophilic one.

More precisely, the PAEKs may be prepared by a nucleophilic aromatic substitution in which a diaryl ether linkage is obtained. The polycondensation is generally conducted in a solvent, such as a diphenyl sulfone, at 300° C. or more with the aid of a base such as K₂CO₃.

More specifically, the PAEK may be obtained by polycondensation of a mixture of at least one aromatic compound bearing two hydroxy groups and at least aromatic compound bearing two halogens, e.g. fluorine. For instance, PEEK is generally prepared by reacting hydroquinone with 4,4′-difluorobenzophenone in diphenylsulfone in the presence of at least one alkali-metal carbonate under an inert atmosphere at high temperatures, e.g. >300° C.

Details about the polycondensation involving the nucleophilic substitution may be found in e.g. U.S. Pat. No. 4,176,222.

More precisely, the PAEKs may be prepared by a Friedel-Crafts electrophilic substitution in which a diaryl ketone linkage is obtained. The polycondensation is generally conducted in a solvent at temperatures below 150° C. with the aid of a Lewis acid such as AlCl₃.

Details about the polycondensation involving the Friedel-Crafts electrophilic substitution may be found in e.g. U.S. Pat. No. 4,841,013, U.S. Pat. No. 4,816,556, WO 2011/004164 and WO 2014/013202.

### PPSU

Composition (C) comprises between 15.0 and 42.0 wt % of at least one polyphenylsulfone. The proportion of PPSU(s) may more particularly be between 20.0 and 40.0 wt %, more particularly between 20.0 and 35.0 wt %. This proportion is preferably between 25.0 and 32.0 wt %.

Composition (C) may comprise only one PPSU.

Composition (C) may also comprise more than one PPSU. In that case, each PPSU may be characterized by distinct recurring units and/or distinct weight average molecular weights (M_{w}). For the avoidance of doubt, it is highlighted that in that case, the proportions given above correspond to the total proportion of PPSUs.

As used herein, “polyphenylsulfone (PPSU)” denotes a polymer of which at least 90.0 mol % of the recurring units are recurring units (R_{PPSU}) of formula (II):

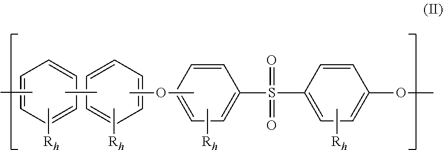

where each R, equal to or different from each other, is selected from a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and each h, equal to or different from each other, is an integer ranging from 0 to 4.

The PPSU is generally amorphous.

Preferably, at least 95.0 mol %, and most preferably at least 99.0 mol %, of recurring units of the PPSU are recurring units (R_{PPSU}). More preferably, all the recurring units of the PPSU are recurring units (R_{PPSU}).

The recurring units (R_{PPSU}) may more particularly be according to following formula (IIa):

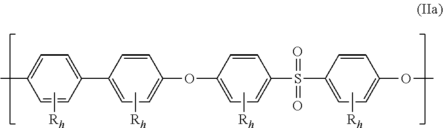

where R and h are as described above.

More particularly, each h is zero.

More preferably, the PPSU denotes a polymer of which at least 90.0 mol % of the recurring units, preferably at least 95.0 mol % of the recurring units, and more preferably all the recurring units are of formula:

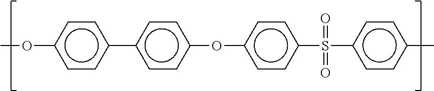

The melt flow rate (MFR) of the PPSU ranges from 5.0 to 60.0 g/10 min, preferably from 10.0 g/10 min to 40.0 g/10 min, most preferably from 10 to 30 g/10 min as measured according to ASTM D1238 at 365° C. with a 5.0 kg weight.

### Preparation of the PPSU

The PPSU is generally prepared by polycondensation based on a nucleophilic aromatic substitution.

The PPSU may thus be prepared by polycondensation of 4,4′-dihydroxybiphenyl (biphenol) and 4,4′-dichlorodiphenyl sulfone in the presence of a base. The reaction of monomer units takes place through nucleophilic aromatic substitution with the elimination of one unit of hydrogen halide as leaving group.

### Inorganic Filler

Composition (C) comprises between 8.0 and 25.0 wt % of at least one inorganic filler. The proportion of the inorganic filler(s) may more particularly be between 10.0and 25.0 wt %, more particularly between 10.0 and 20.0 wt %.

According to an embodiment, the proportion of inorganic filler(s) is at least 12.0 wt % or even at least 14.0 wt %. This proportion is preferably between 14.0 and 20.0 wt %.

According to another embodiment, the proportion of inorganic filler(s) is between 10.0 and 15.0 wt %.

The function of the inorganic filler is to increase the modulus while keeping the ductility of the composition.

The inorganic filler may for instance be selected in the group consisting of talc, mica and combinations thereof. Preferably, the inorganic filler is talc.

Preferably, the inorganic filler exhibits an aspect ratio, defined as the average ratio between the length and the smallest of the width and thickness of at least 5. Preferably, the aspect ratio is at least 10, still more preferably at least 20.

Preferably, the inorganic filler exhibits a D50 lower than than 20.0 microns, preferably lower than than 10.0 microns and most preferably lower than 5.0 microns, D50 being the median of a distribution of size in volume obtained by laser diffraction measurement. Generally, D50 is at least 0.5 microns.

### Nucleating Agent

Composition (C) may optionally comprise at most 3.0 wt % of at least one nucleating agent. When present, the proportion of the nucleating agent(s) may be between 0.1 and 3.0 wt % or between 0.1 and 1.5 wt %.

The nucleating agent may be selected from the group consisting of graphite, graphene, boron nitride and a combination thereof. Preferably, the nucleating agent is boron nitride. Boron nitride does not turn the slot liner black in color, which makes it easier to detect defects.

The nucleating agent helps speed up the crystallization process when the composition is being extruded into a film. The faster crystallization allows the film to attain a higher crystallinity thereby allowing better mechanical properties, in particular a higher modulus.

### Plastic Additive(s)

Composition (C) may also comprise at least one plastic additive. A plastic additive denotes any additive that improves the stability, the processability or the use of an already formed polymer. The plastic additive may more particularly be selected from the group consisting of colorants (e.g. dyes and/or pigments), ultraviolet light stabilizer, heat stabilizers, antioxidants, internal lubricants and/or external lubricants, flame retardants, anti-static agents, anti-blocking agents and combinations thereof.

The proportion of the plastic additive(s) is generally lower than 5.0 wt %, even lower than 2.0 wt %.

According to a preferred embodiment, composition (C) comprises only one or more PAEKs and one or more PPSUs as polymers present in the composition.

According to a preferred embodiment, composition (C) comprises only one PAEK and one PPSU as polymers present in the composition.

According to another preferred embodiment, the total proportion of PAEK(s) and PPSU(s) is at least 80.0 wt %, preferably at least 85.0 wt %.

According to another preferred embodiment, the weight ratio of PAEK(s)/PPSU(s) is between 60/40 and 70/30. This ratio may be between 62/38 and 68/32 or between 64/36 and 66/34.

### Composition (C*)

Composition (C) is more particularly a composition (C*) comprising or consisting essentially of or consisting of:
at least 50.0 wt % of at least one polyaryletherketone (PAEK) selected from the group consisting of PEEK and PEKK;
between 15.0 and 42.0 wt % of at least one polyphenylsulfone (PPSU);
between 8.0 and 25.0 wt % of at least one inorganic filler, preferably talc;
optionally at most 3.0 wt % of at least one boron nitride;
optionally at least one plastic additive.

The proportions are notably the following ones:
between 50.0 and 60.0 wt % of at least one polyaryletherketone (PAEK) selected from the group consisting of PEEK and PEKK;
between 25.0 and 32.0 wt % of at least one polyphenylsulfone (PPSU);
between 10.0 and 20.0 wt % of at least one inorganic filler, preferably talc;
optionally at most 3.0 wt % of at least one boron nitride;
optionally at least one plastic additive.

All precisions and embodiments already disclosed for composition (C) apply for composition (C*).

### Physico-Chemical Properties of the Component or Composition (C) and (C*)

The component and/or the composition (C) or (C*) exhibit a combination of properties.

According to an embodiment, compositions (C) and (C*) exhibit a tensile elongation at break of at least 10.0%, preferably at least 15.0%, preferably at least 18.0%, as measured according to ASTM D638 at a test speed of 50 mm/min.

According to an embodiment, compositions (C) and (C*) exhibit a tensile modulus of at least 4.82 GPa as measured according to ASTM D638 at a test speed of 50 mm/min.

According to an embodiment, compositions (C) and (C*) exhibit a heat deflection temperature of at least 180° C., preferably at least 190° C., measured at a stress of 1.82 MPa and per ASTM D648 on annealed 3.2 mm thick specimens (annealing conditions: 2 hours at 200° C.). The heat deflection temperature is preferably at least 195° C.

According to a preferred embodiment, compositions (C) and (C*) exhibit:
a tensile elongation at break of at least 10.0%, preferably at least 15.0%, preferably at least 18.0%, as measured according to ASTM D638 at a test speed of 50 mm/min; and
a heat deflection temperature of at least 180° C., preferably at least 190° C., preferably at least 195° C., measured at a stress of 1.82 MPa and per ASTM D648 on annealed 3.2 mm thick specimens (annealing conditions: 2 hours at 200° C.).

According to an embodiment, compositions (C) and (C*) exhibit:
a tensile modulus of at least 4.82 GPa (700 Kpsi) as measured according to ASTM D638 at a test speed of 50 mm/min (2 in/min); and
a tensile elongation at break of at least 10.0% as measured according to ASTM D638 at a test speed of 50 mm/min (2 in/min); and
a heat deflection temperature of at least 180° C., preferably at least 190° C., measured at a stress of 1.82 MPa (264 psi) and per ASTM D648 on annealed 3.2 mm thick specimens (annealing conditions: 2 hours at 200° C.).

The tensile modulus is generally at most 5.9 GPa (850 Kpsi) or even at most 5.2 GPa (750 Kpsi).

The tensile elongation at break is generally at most 25.0%.

The heat deflection temperature is generally at most 230° C.

The conditions of the measurement of the physico-chemical properties may be found in the experimental section.

Typically, the compositions (C) and (C*) are semi-crystalline. Moreover, they preferably exhibit a heat of fusion which is at least 20.0 J/g, more preferably at least 25.0 J/g and most preferably at least 30.0 J/g, the heat of fusion being expressed as the enthalpy of fusion over the polymer content of the composition. This level of crystallinity ensures that the composition, notably in the form of a film, will resist the chemical environments that are encountered in an electric motor environment. Indeed, the composition (C) needs to resist environments such as automatic transmission fluid and impregnation resins used to encapsulate the motor windings.

### Insulation Properties

Compositions (C) and (C*) and the component exhibit also insulation properties:
a Partial Discharge Inception Voltage (PDIV) of at least 900 V, preferably at least 1000 V, more preferably at least 1100 V, measured according to ASTM D1868, for a thickness of 100 micron; and/or
a Breakdown Voltage (BV) of at least 11 kV, preferably at least 12 kV, more preferably at least 13 kV, measured according to ASTM D149, for a thickness of 100 micron.

### Preparation of composition (C)/(C*)

Typically, the ingredients of composition (C) or (C*) are blended together, notably by incorporating the ingredients in a mixing apparatus.

The ingredients are typically blended so as to form an homogeneous physical mixture.

Compositions (C) and (C*) are typically manufactured by any known melt-mixing process that is suitable for preparing thermoplastic compositions or compounds. This process can be carried out in a melt-mixing apparatus. Any melt-mixing apparatus known to the one skilled in the art of preparing polymer compositions by melt mixing can be used.

The mixing apparatus used for the preparation of the composition can typically be selected in the list consisting of kneaders, Banbury mixers, single-screw extruders and twin-screw extruders. A convenient mixing apparatus that can be used for the preparation of the composition is a single-screw extruder or a twin-screw extruder. A convenient mixing apparatus can be one of those disclosed in the experimental section.

The design of the compounding screw (e.g. flight pitch and width, clearance, length) as well as the operating conditions of the extruder are preferably and advantageously chosen so that sufficient heat and mechanical energy is provided to fully melt the polymer ingredients and obtain a homogeneous distribution of the various ingredients. At the outlet of the extruder, strand extrudates of the composition can be chopped by means e.g. of a rotating cutting knife after some cooling time on a conveyer with water spray.

Compositions (C) and (C*) may be in the form of a powder or in the form of pellets. The latter form is preferred as being more convenient to use.

### Experimental Section

Starting Materials Used: the polymers used in the examples were:

PAEK: polyetheretherketone (PEEK)—grade KetaSpire KT-880 NT available from Solvay Specialty Polymers. This grade has a melt viscosity in the range 120-180 Pa-s as measured per ASTM D3835 at 400° C. and a shear rate of 1000 1/s.

PAEK: polyetheretherketone (PEEK)—grade KetaSpire KT-852 NT available from Solvay Specialty Polymers. This grade has a melt viscosity in the range 270-330 Pa-s as measured per ASTM D3835 at 400° C. and a shear rate of 1000 1/s.

PAEK: polyetheretherketone (PEEK)—grade KetaSpire KT-820 NT available from Solvay Specialty Polymers. This grade has a melt viscosity in the range 380-500 Pa-s as measured per ASTM D3835 at 400° C. and a shear rate of 1000 1/s.

Polyphenylsulfone (PPSU): grade R-5100 NT available from Solvay Specialty Polymers. This grade exhibits a MFR of 14-20 g/10 min as measured according to ASTM D1238 using a temperature of 365° C. and 5.0 kg weight.

Polyethersulfone (PES); grade A-301 NT available from Solvay Specialty Polymers

The minerals and other additives used were the following:

Talc—grade Mistron® from Imerys Perfomance Additives; D50 of about 2 μm.

Boron nitride—grade Boronid® S1-SF available from 3M Corporation.

Zinc oxide—grade Activ® R-609, which was procured from Lanxess Corporation.

Zinc stearate—grade 2222 from Baerlocher Corporation.

Preparation of compositions disclosed in Table II: all these compositions were prepared by first tumble blending pellets or powders of the resins and additives to be blended at the desired compositional ratios for about 20 minutes, followed by melt compounding the obtained mixture using a 26 mm diameter Coperion ZSK-26 co-rotating partially intermeshing twin screw extruder having an L/D ratio of 48:1. The extruder had 12 barrel sections with barrel sections 2 through 11 being heated with set point temperature of 350° C. The die section was also set to a temperature of 350° C. The ingredient mixture pre-blend was fed at barrel section 1 using a gravimetric feeder at nominal throughput rates ranging from 17.5 to 28 lb/hr. The extruder was operated at a screw speed of about 200 rpm and vacuum venting was applied at barrel section 10 during compounding to strip off moisture and any possible residual volatiles from the compound. A single-hole die was used for all the compounds and the molten polymer strand exiting the die was cooled in a water trough and then cut in a pelletizer to form pellets approximately 3.0 mm in length by 2.7 mm in diameter.

Preparation of compositions CE3 and E5 of Table III: these two compositions were produced on an production scale equipment using a Coperion ZSK-40 co-rotating partially intermeshing twin screw extruder having 12 barrel sections and a L/D ratio of 48. The feeding to the compounding extruder was performed by metering the resin ingredients (which were preblended, if more than one) in one gravimetric feeder and the powderous additives (also preblended) in another gravimetric feeder. The feeding rate ratio of the resins preblend to the additives preblend was tuned so as to exactly achieve the proportions listed in Table III. The extruder operating parameters used during compounding are shown in Table I below:

TABLE I

| Process Parameter | CE17 | Process Parameter | E5 |
|---|---|---|---|
| Barrel Section 1 Temp. | 150 | Barrel Section 1 Temp. | 150 |
| Set Point, ° C. | | Set Point, ° C. | |
| Barrel Section 2 Temp. | 300 | Barrel Section 2 Temp. | 300 |
| Set Point, ° C. | | Set Point, ° C. | |
| Barrel Section 3 Temp. | 370 | Barrel Section 3 Temp. | 370 |
| Set Point, ° C. | | Set Point, ° C. | |
| Barrel Section 4 Temp. | 370 | Barrel Section 4 Temp. | 370 |
| Set Point, ° C. | | Set Point, ° C. | |
| Barrel Section 5 Temp. | 370 | Barrel Section 5 Temp. | 370 |
| Set Point, ° C. | | Set Point, ° C. | |
| Barrel Section 6 Temp. | 370 | Barrel Section 6 Temp. | 370 |
| Set Point, ° C. | | Set Point, ° C. | |
| Barrel Section 7 Temp. | 370 | Barrel Section 7 Temp. | 370 |
| Set Point, ° C. | | Set Point, ° C. | |
| Barrel Section 8 Temp. | 360 | Barrel Section 8 Temp. | 360 |
| Set Point, ° C. | | Set Point, ° C. | |
| Barrel Section 9 Temp. | 360 | Barrel Section 9 Temp. | 360 |
| Set Point, ° C. | | Set Point, ° C. | |
| Barrel Sec. 10 Temp. | 360 | Barrel Sec. 10 Temp. | 360 |
| Set Point, ° C. | | Set Point, ° C. | |
| Barrel Sec. 11 Temp. | 360 | Barrel Sec. 11 Temp. | 360 |
| Set Point, ° C. | | Set Point, ° C. | |
| Barrel Sec. 12 Temp. | 360 | Barrel Sec. 12 Temp. | 360 |
| Set Point, ° C. | | Set Point, ° C. | |
| Die Temperature | 380 | Die Temperature | 380 |
| Set Point, ° C. | | Set Point, ° C. | |
| Actual Melt | 416 | Actual Melt | 404 |
| Temperature, ° C. | | Temperature, ° C. | |
| Screw RPM | 200 | Screw RPM | 381 |
| Torque, % | 70 | Torque, % | 36 |
| Vacuum Level (in Hg) | 30 | Vacuum Level (in Hg) | 28 |
| Total Feed Rate (lb/hr) | 140 | Total Feed Rate (lb/hr) | 100 |

### Injection Molding

Injection molding was used to produce the test specimens for the measurement of the mechanical properties and heat deflection temperature. 25 tensile and 25 flexural specimens were prepared from each composition. The tensile test specimens were 3.2 mm (0.125 in) thick type I ASTM tensile bars according to ASTM specification D638 and the flexural specimens were 5 in×0.5 in×0.125 in dimensions. The mechanical test specimens were injection molded using the following approximate set point conditions which are in harmony with injection molding guidelines recommended by the suppliers for the different polymers: Rear barrel section: 710° F. (376° C.); Middle barrel section: 710° F. (376° C.); Front barrel section: 710° F. (376° C.); Nozzle: 710° F. (376° C.); Mold: 410° F. (210° C.).

The following ASTM test methods were employed in evaluating all compositions and are considered in the context of the present invention:

### Testing

D638: Tensile properties, measured at a test speed of 2 in/min (50 mm/min)
D648: Heat deflection temperature at 264 psi, measured on specimens annealed for 2 hours at 200° C.
D149: Dielectric breakdown voltage (conducted on films of 4 mil (100 micron) nominal thickness)

All mechanical tests except heat deflection temperature were carried out on as molded test parts. Mechanical properties were measured on injection molded ASTM 3.2 mm thick specimens. The heat deflection temperature test was conducted on annealed specimens using the annealing condition of 200° C. for 1 hour in a forced air oven.

TABLE II

| examples | CE1 | CE2 | E1 | E2 | E3 | E4 |
|---|---|---|---|---|---|---|
| PEEK/PAES | 100/0 | 65/35 | 65/35 | 65/35 | 65/35 | 65/35 |
| wt. Ratio | | | | | | |
| PEEK Grade | KT-820 NT | KT-880 NT | KT-852 NT | KT-852 NT | KT-820 NT | KT-820 NT |
| Used | | | | | | |
| PAES | None | 50/50 | R-5100 NT | R-5100 NT | R-5100 NT | R-5100 NT |
| | | R-5100/ | | | | |
| | | A-301 NT | | | | |
| wt. % PEEK | 90 | 53.76 | 53.56 | 53.75 | 53.56 | 53.75 |
| wt. % PPSU | 0 | 14.47 | 28.84 | 28.95 | 28.84 | 28.95 |
| wt. % PES | 0 | 14.47 | 0 | 0 | 0 | 0 |
| wt. % Talc | 0 | 15.9 | 17.4 | 15.9 | 17.4 | 15.9 |
| wt. % BN | 10 | 1.2 | 0 | 1.2 | 0 | 1.2 |
| wt. % ZnO | 0 | 0.1 | 0.1 | 0.1 | 0.1 | 0.1 |
| wt. % Zn | 0 | 0.1 | 0.1 | 0.1 | 0.1 | 0.1 |
| Stearate | | | | | | |

Properties

| | | | | | | |
|---|---|---|---|---|---|---|
| TM (Ksi) | 838 | 832 | 764 | 795 | 795 | 799 |
| TEB (%) | 36 | 4.9 | 13 | 12 | 14 | 16 |
| BDV (kV) | 16.0 | 12.9 | 13 | 12.2 | 11.9 | 12.6 |
| PDIV (V) | 897 | / | 1088 | 1116 | 1111 | 1110 |
| Heat | 167 | 205 | 195 | 193 | 194 | 193 |
| Deflection | | | | | | |
| Temp. (° C.) | | | | | | |

All extruded films were of 4 mil (100 micron) nominal thickness
PAES: polyarylethersulfone (PPSU, PES)
TM: tensile modulus;
TEB: tensile elongation at break

As can be seen, the compositions of the examples E1-E4 exhibit a better combination of properties than the compositions of comparative examples CE1 and CE2. Composition CE1 exhibits a low heat deflection temperature. Composition CE2 exhibits a high deflection temperature (205° C.) but the TEB is low.

TABLE III

| Example → | CE3 | E5 |
|---|---|---|
| PEEK/PPSU Wt. Ratio | 100/0 | 65/35 |
| PEEK Grade Used | KT-852 NT | KT-852 NT |
| PPSU Component | None | R-5100 NT |
| Wt. % PEEK | 97.5 | 56.74 |
| Wt. % PPSU | — | 30.56 |
| Wt. % Talc | 11.3 | 11.3 |
| Wt. % BN | 1.2 | 1.2 |
| Wt. % ZnO | — | 0.1 |
| Wt. % Zn Stearate | — | 0.1 |
| Calcium Stearate | 0.01 pph | — |
| Dusting on Pellets | | |
| Properties | | |
| Tensile Modulus (Ksi) | 857 | 710 |
| Tensile Elongation at Break (%) | 19 | 20 |
| Heat Deflection Temp. (° C.) | 168 | 196 |

As can be seen with the results of Table III, the composition of example E5 exhibits a higher Tensile Elongation at Break (TEB) and a higher heat deflection temperature than the composition of comparative example CE3.

Films of the two compositions CE3 and E5 were also extruded at four different nominal thicknesses: 50, 100, 150 and 200 microns and a width of 36 inches. A single screw extruder was used for this purpose. The extruder had a single stage non-vented screw with a diameter of 2.5 inches, an L/D ratio of 30 and a compression ratio of 3.0. It was equipped with a 46 inch wide film die yielding a final film width of 36 inches after trimming of the outer edges. The operating conditions of the extruder, die and take up system are summarized in Table 4 below. The resin compositions were dried at 300° F. for 4 hours in a desiccated drying hopper prior to extrusion.

The conditions of the extrusion of the films were the following:

TABLE IV

| Operating Conditions | CE3 | E5 |
|---|---|---|
| Barrel temperature range (° F.) | 740-805 | 740-810 |
| Die zone Temperature range (° F.) | 730-760 | 740-800 |
| Heated roll temperature range (° F.) | 300-365 | 300-365 |
| Screw speed (RPM) | 40-90 | 30-70 |
| Line speed (ft/min) | 5-30 | 5-30 |

The extruded films at various thicknesses were subjected to breakdown voltage and partial discharge inception voltage testing. The results from this testing are summarized in Table V.

TABLE V

| Nominal | Breakdown | | Partial Discharge | |
|---|---|---|---|---|
| Thickness | Voltage (kV) | | Inception Voltage (V) | |
| (μm) | CE3 | E5 | CE3 | E5 |
| 50 | 7.1 | 7.4 | 678 | 902 |
| 100 | 12.0 | 12.7 | 817 | 809 |
| 150 | 15.4 | 15.8 | 973 | 978 |
| 200 | 17.6 | 18.9 | 1052 | 1059 |

As can be seen from all these results, the electrical insulation capability of films made from the compositions of this invention exhibit improved insulation properties over the comparative example CE3.

1. A component for use as an electrical insulation barrier in the slots of a stator, wherein the component comprises or is made of a composition (C) which comprises or consists essentially of or consists of:
at least 50.0 wt % of at least one polyaryletherketone (PAEK);
between 15.0 and 42.0 wt % of at least one polyphenylsulfone (PPSU);
between 8.0 and 25.0 wt % of at least one inorganic filler;
optionally at most 3.0 wt % of at least one nucleating agent other than the inorganic filler;
optionally at least one plastic additive;
wherein the component is a slot liner or a slot wedge.

2. A component according to claim 1 wherein the composition (C) comprises:
only one PAEK; or
more than one PAEK.

3. A component according to claim 1, wherein composition (C) is in the form of an homogeneous physical mixture.

4. A component according to any one of claims 1-3 wherein the proportion of PAEK(s) in the composition (C) is between 50.0 and 65.0 wt %.

5. A component according to any one of claims 1-4 wherein the proportion of PAEK(s) in the composition (C) is between 53.0 and 60.0 wt % or between 55.0 and 60.0 wt %.

6. A component according to any one of the preceding claims wherein the at least one PAEK exhibits a heat of fusion as measured from the second heat of differential scanning calorimetry test according to ASTM D3418-03 of at least 35.0 J/g, preferably at least 40.0 J/g, and more preferably at least 45.0 J/g.

7. A component according to any one of the preceding claims wherein the at least one PAEK exhibits a melt viscosity of at least 200 Pas measured according to ASTM D3835 at 400° C. and a 1000 1/s shear rate.

8. A component according to any one of the preceding claims wherein the at least one PAEK exhibits a melt viscosity between 200 and 600 Pa s, preferably between 250 and 600 Pa s measured according to ASTM D3835 at 400° C. and a 1000 1/s shear rate.

9. A component according to any one of the preceding claims wherein the PAEK exhibits a melting temperature of at least 300° C., preferably at least 320° C.

10. A component according to any one of the preceding claims wherein the PAEK comprises arylene groups linked by oxygen atoms and/or carbonyl groups and wherein the polymer comprises more than 50.0 mol % of recurring units (RPAEK) including the unit of formula (I):
—Ar′—C(═O)—Ar″—(I)
where Ar′ and Ar″, equal to or different from each other, are optionally substituted arylene groups, the recurring units (RPAEK) being notably selected in the group consisting of units of formulae (J-A) to (J-Q) below: 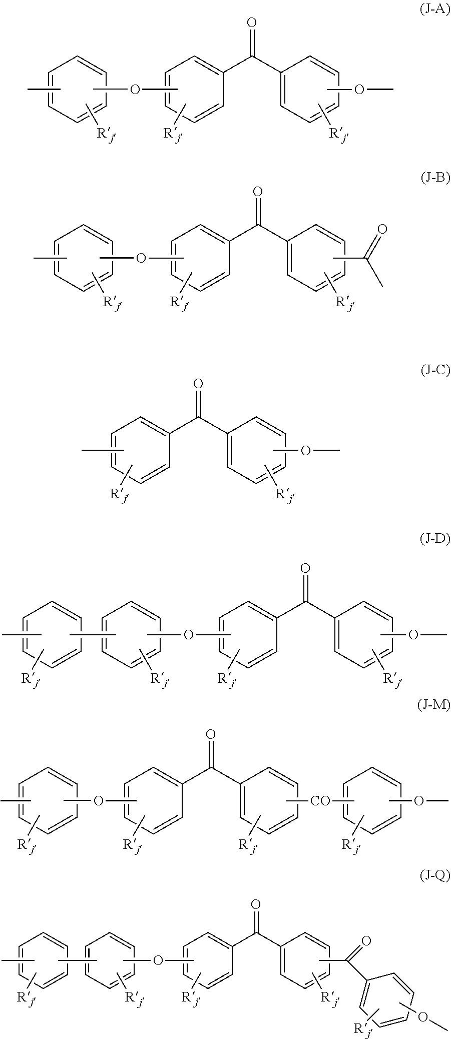
where each R′ of R′_{j′}, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and j′ is zero or an integer ranging from 1 to 4, j′ being preferably zero.

11. A component according to any one of the preceding claims wherein the PAEK is selected from the group consisting of PEEK, PEKK, PEK, PEEKK, PEKEKK and combinations thereof.

12. A component according to any one of the preceding claims wherein the PAEK is selected from the group consisting of PEEK, PEKK and combinations thereof.

13. A component according to claim 11 or 12, wherein:
PEEK denotes a polymer of which more than 50.0 mol % of the recurring units; preferably more than 95.0 mol % of the recurring units; preferably more than 99.0 mol % of the recurring units or most preferably all of recurring units are recurring units of formula (J′-A): 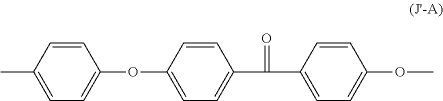
PEKK denotes a polymer of which more than 50.0 mol % of the recurring units;
preferably more than 95.0 mol % of the recurring units; preferably more than 99.0 mol % of the recurring units or most preferably all of the recurring units are a combination of recurring units of formula (J′-B) and formula (J″-B): 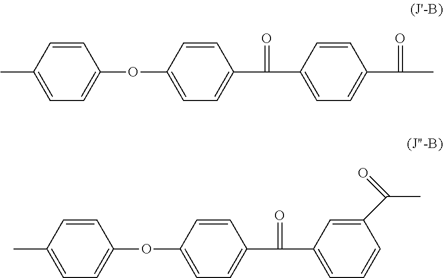
PEK denotes a polymer of which more than 50.0 mol % of the recurring units; preferably more than 95.0 mol % of the recurring units; preferably more than 99.0 mol % of the recurring units or most preferably all of recurring units are recurring units of formula (J′-C): 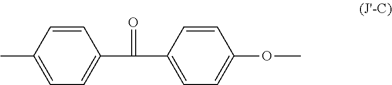
PEEKK denotes a polymer of which more than 50.0 mol % of the recurring units; preferably more than 95.0 mol % of the recurring units; preferably more than 99.0 mol % of the recurring units or most preferably all of recurring units are recurring units of formula (J′-M): 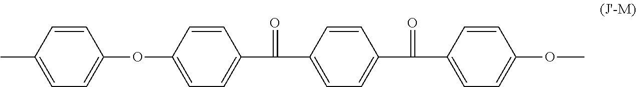
PEKEKK denotes a polymer of which more than 50.0 mol % of the recurring units; preferably more than 95.0 mol % of the recurring units; preferably more than 99.0 mol % of the recurring units or most preferably all of recurring units are recurring units of formula (J′-Q):

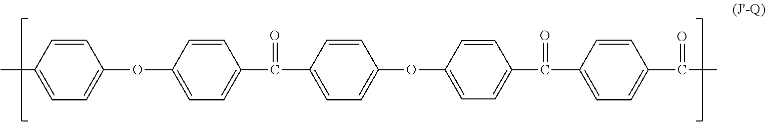

14. A component according to any one of the preceding claims wherein the PAEK is a PEEK of which more than 95.0 mol %, preferably at least 99.0 mol % of the recurring units are of formula (J′-A):

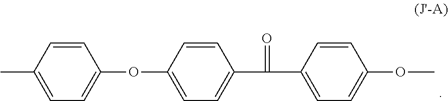

15. A component according to any one of the preceding claims wherein the composition (C) comprises only one PPSU.

16. A component according to any one of the preceding claims wherein the composition (C) comprises more than one PPSU.

17. A component according to any one of the preceding claims, wherein the proportion of PPSU(s) in the composition (C) is between 20.0 and 40.0 wt %, preferably between 25.0 and 32.0 wt %.

18. A component according to any one of the preceding claims, wherein the PPSU denotes a polymer of which at least 90.0 mol %; preferably at least 95.0 mol %, more preferably at least 99.0 mol % of the recurring units or most preferably all of the recurring units are of formula:

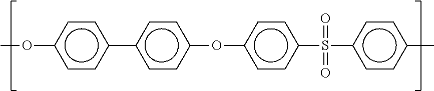

19. A component according to any one of the preceding claims wherein the at least one PPSU in the composition (C) exhibits a melt flow rate (MFR) ranging from 5.0 to 60.0 g/10 min, preferably from 10.0 g/10 min to 40.0 g/10 min, most preferably from 10 to 30 g/10 min as measured according to ASTM D1238 at 365° C. with a 5.0 kg weight.

20. A component according to any one of the preceding claims, wherein the proportion of the inorganic filler(s) in the composition (C) is between 10.0 and 25.0 wt %, preferably between 10.0 and 20.0 wt %, preferably between 14.0 and 20.0 wt %.

21. A component according to any one of the preceding claims, wherein the proportion of the inorganic filler(s) in the composition (C) is between 10.0 and 15.0 wt %.

22. A component according to any one of the preceding claims wherein the inorganic filler in the composition (C) is selected from the group consisting of talc, mica and combinations thereof, preferably is talc

23. A component according to any one of the preceding claims wherein the inorganic filler exhibits an aspect ratio, defined as the average ratio between the length and the smallest of the width and thickness of at least 5, preferably of at least 10, still more preferably of at least 20.

24. A component according to any one of the preceding claims wherein the inorganic filler in the composition (C) exhibits a D50 lower than 20.0 microns, preferably lower than 10.0 microns and most preferably lower than 5.0 microns, D50 being the median of a distribution of size in volume obtained by laser diffraction measurement.

25. A component according to any one of the preceding claims, wherein the composition (C) comprises at least one nucleating agent, which is preferably boron nitride.

26. A component according to any one of the preceding claims, wherein the proportion of nucleating agent(s) is between 0.1 and 3.0 wt % or between 0.1 and 1.5 wt %.

27. A component according to any one of the preceding claims wherein the composition (C) comprises only one or more PAEKs and only one or more PPSUs as polymers present in the composition.

28. A component according to any one of the preceding claims wherein composition (C) comprises only one PAEK and only one PPSU as polymers present in the composition.

29. A component according to any one of the preceding claims wherein the total proportion of PAEK(s) and PPSU(s) is at least 80.0 wt %, preferably at least 85.0 wt %.

30. A component according to any one of the preceding claims wherein the weight ratio of PAEK(s)/PPSU(s) is between 60/40 to 70/30.

31. A component according to any one of the preceding claims wherein the weight ratio of PAEK(s)/PPSU(s) is between 62/38 and 68/32 or between 64/36 and 66/34.

32. A component according to any one of the preceding claims, wherein the composition (C) exhibits a heat of fusion which is at least 20.0 J/g, more preferably at least 25.0 J/g and most preferably at least 30.0 J/g, the heat of fusion being expressed as the enthalpy of fusion over the polymer content of the composition.

33. A component according to any one of the preceding claims, wherein the composition (C) is a composition (C*) comprising or consisting essentially of or consisting of:
at least 50.0 wt % of at least one polyaryletherketone (PAEK) selected from the group consisting of PEEK and PEKK;
between 15.0 and 42.0 wt % of at least one polyphenylsulfone (PPSU);
between 8.0 and 25.0 wt % of at least one inorganic filler, preferably talc;
optionally at most 3.0 wt % of at least one boron nitride;
optionally at least one plastic additive.

34. A component according to any one of the preceding claims, wherein the composition (C) is a composition (C*) comprising or consisting essentially of or consisting of:
between 50.0 and 60.0 wt % of at least one polyaryletherketone (PAEK) selected from the group consisting of PEEK and PEKK;
between 25.0 and 32.0 wt % of at least one polyphenylsulfone (PPSU);
between 10.0 and 20.0 wt % of at least one inorganic filler, preferably talc;
optionally at most 3.0 wt % of at least one boron nitride;
optionally at least one plastic additive.

35. A component according to any one of the preceding claims, wherein composition (C) exhibits a tensile elongation at break of at least 10.0%, preferably at least 15.0%, preferably at least 18.0%, as measured according to ASTM D638 at a test speed of 50 mm/min.

36. A component according to any one of the preceding claims, wherein composition (C) exhibits a tensile modulus of at least 4.82 GPa as measured according to ASTM D638 at a test speed of 50 mm/min.

37. A component according to any one of the preceding claims, wherein composition (C) exhibits a heat deflection temperature of at least 180° C., preferably at least 190° C., at a stress of 1.82 MPa as measured per ASTM D648 on annealed 3.2 mm thick specimens (annealing conditions: 2 hours at 200° C.).

38. A component according to any one of the preceding claims, exhibiting a Partial Discharge Inception Voltage (PDIV) of at least 900 V, preferably at least 1000 V, more preferably at least 1100 V, measured according to ASTM D1868, for a thickness of 100 micron.

39. A component according to any one of the preceding claims, exhibiting a Breakdown Voltage (BV) of at least 11 kV, preferably at least12 kV, more preferably at least 13 kV, measured according to ASTM D149, for a thickness of 100 micron.

40. A component according to any one of the preceding claims wherein the composition (C) exhibits the following properties:
a tensile modulus of at least 4.82 GPa as measured according to ASTM D638 at a test speed of 50 mm/min; and
a tensile elongation at break of at least 10.0%, preferably at least 15.0%, preferably at least 18.0%, as measured according to ASTM D638 at a test speed of 50 mm/min; and
a heat deflection temperature of at least 180° C., preferably at least 190° C., preferably at least 195° C., at a stress of 1.82 MPa as measured per ASTM D648 on annealed 3.2 mm thick specimens (annealing conditions: 2 hours at 200° C.).

41. A component according to any of the preceding claims in the form of a film with a thickness lower than 1.0 mm, preferably lower than 0.50 mm, even more preferably lower than 0.20 mm.

42. Use of a composition as defined in any one of claims 1-40 for the preparation of a slot liner or a slot wedge.

43. An electric motor comprising a component as defined in any one of claims 1-41.

44. An electric motor according to claim 43 which comprises a stator and a rotor and wherein the component is inserted into the slots of the stator.

45. An electric generator comprising a component as defined in any one of claims 1-41.

46. An electric generator according to claim 45 which comprises a stator and a rotor and wherein the component is inserted into the slots of the stator.

47. Composition (C) as defined in any one of the claims 1-36.
